(19) United States
(12) Patent Application Publication
(10) Pub. No.: US 2011/0102436 A1
(43) Pub. Date: May 5, 2011

(54) SMOOTH SHADING AND TEXTURE MAPPING USING LINEAR GRADIENTS

(75) Inventors: Gershon Elber, Haifa (IL); Amir Fischer, Tel Aviv (IL)

(73) Assignee: REVOLVER LTD., Herzliya (IL)

(21) Appl. No.: 12/518,606

(22) PCT Filed: Dec. 13, 2007
(86) PCT No.: PCT/IL07/01549

§ 371 Date: Sep. 8, 2009

(30) Foreign Application Priority Data
Dec. 14, 2006 (IL) 180102

(51) Int. Cl. G06T 15/60

(52) U.S. Cl. 345/426

(57) ABSTRACT

Method for shading 3D graphic models using 2D graphic tools, wherein the 3D graphic model is constructed of any number of polygons, according to which, each polygon is subdivided into triangles while mapping the spatial orientation and scaling of each triangle to a predetermined spatial orientation and scale, using a combination of rotation, scaling, and linear translation. Each mapped triangle is shaded using 2D linear or bi-linear coloring map shading tools and then remapped to its original spatial orientation and scale using, a corresponding combination of rotation, scale, and linear translation, such as an inverse combination.

### FIELD OF THE INVENTION

The present invention relates to the field of computer generated images. More specifically, this invention relates to a method for smooth shading and texture mapping using linear gradients.

### BACKGROUND OF THE INVENTION

3D computer graphics is the art of using digital computers and dedicated 3D software applications to create a collection of graphical objects that can be displayed on a suitable terminal device. Although many computer applications are currently implemented using 3D graphics, some environments, such as Macromedia Flash© Technology (MFT), are inherently two-dimensional (2D).

Among the drawbacks of 2D graphics, in relation to 3D graphics, is the feature of coloring, shading and texture mapping of the displayed objects. 2D graphic tools allow one to fill the polygon with colors that change gradually. MFT, for example, allows two types of gradual painting, either along linear trajectories, or along circular trajectories. However, such 2D applications do not support shading or texture mapping of 3D graphic models.

When creating computer graphic models, each shape in the model must be constructed by certain modeling techniques. Several modeling techniques are known in the art, including polygonal modeling (information related to polygonal modeling may be found, for example, at http://en.wikipedia.org/wiki/Polygonal_modeling). Models can be created with a wide variety of commercial modeling tools, such as AutoCAD© and Solid Works©.

Polygons are simple primitives, virtually used by almost all rendering tools, as their basic primitives. Typically, polygons are approximated from other geometric representations such as spline (curved) surfaces. Then, scenes are typically converted into polygons, usually triangles. The main advantage of polygonal representation is that it is more efficient than other types of graphic representations for rendering and picture making needs.

Rendering of 3D computer graphics consists of several stages that each individual polygon of the 3D model undergoes. First hidden surface removal, transformation and projection of the polygons are performed, thereby creating the desired image. These steps are followed by shading and/or texture mapping of the polygons. Finally, the polygons are painted according to their position in the image.

The present invention is focused on the shading and texture mapping steps of the process described shortly above. Furthermore, since the polygons are usually triangular, all polygons are referred to as such, though, as would be understood by those familiar with the art, the method proposed by the present invention can be used for any polygon, disregarding its shape.

The simplest shading technique of computer generated images is known in the art as flat shading. When a triangle T(p1,p2,p3) is flat shaded, it is filled with a single fixed color, and thus, the polygon looks flat. However, although flat shading is computationally efficient, the quality of the generated images is relatively low.

An improved shading technique is known in the art as Gouraud shading. Gouraud shading is used to simulate the differing effects of light and color across the surface of an object. It achieves smooth shading on polygon surfaces without requiring relatively heavy computational operations for calculating the shading for each pixel.

According to the Gouraud shading technique, three different shading levels are assigned to the three vertices (p1,p2,p3) of each triangle T(p1,p2,p3). These shading levels are linearly interpolated in the interior of the triangle. The basic principle behind this technique is to calculate the surface normals at the vertices of the polygons in a 3D computer model. These normals can be computed as an average of all polygons' normals that share this specific vertex in the model, or as the precise normal of the smooth model at that location. Lighting computations, usually based on the Lambertian diffuse lighting model, are then performed to produce color intensities at each point (information related to the Lambertian diffuse lighting model may be found, for example, at http://en.wikipedia.org/wiki/Lambertian_diffuselighting_model).

The generated color values are then interpolated along the edges of the polygons. To complete the shading, the image is filled by lines drawn across the image that interpolate between the previously calculated edge intensities.

In order to support Gouraud shading, modern computers typically include special hardware that is capable of performing all of the necessary color interpolations in the interior of the polygon. Furthermore, the Gouraud method, as known today, is inherently related to 3D graphics, and thus, applications supporting only 2D graphics cannot use Gouraud shading.

It would therefore be highly desirable to allow any computer application to utilize the smooth Gouraud shading technique using 2D features.

The present invention relates to the texture mapping of graphic models as well. One of the most common texture mapping techniques builds a bi-variate parameterization from a rectangular, i.e., parametric, domain, to the surface of the model. Such a technique is generally displayed in FIG. 1.

Rectangle J, which is a 2D parametric domain mapped to the unit square [0,1]x[0,1], is filled with the texture which will ultimately be mapped onto model M. Parametric coordinates (u,v), u,vε[0,1] are assigned to every point Pᵢ in triangle T in model M, in the 2D parametric domain J. This is true for all triangles in M, so that every triangle in M covers some triangular domain in J, and all of the triangles in M together capture all (or portions of) 2D parametric domain J.

Although many contemporary personal computers support texture mapping using special hardware graphics which essentially paint model M, pixel by pixel, according to a 2D parametric domain J, not all computer applications support such texture mapping. MFT for example, does not provide such tools. MFT, and the like, provide graphic tools for texture mapping of 2D simple models only, but not 3D models.

Therefore it would be highly desirable to be able to exploit 2D image processing applications in order to cover an entire 3D model with texture.

It is an object of the present invention to provide a method by which Gouraud shading of 3D models can be performed using the ordinary features of 2D graphics packages.

It is a further object of the present invention to provide a method by which the texture mapping of 3D graphic models can be performed using ordinary 2D tools.

Additional purposes and advantages of this invention will become apparent as the description proceeds.

### SUMMARY OF THE INVENTION

The present invention is directed to a method for shading 3D graphic models using 2D graphic tools, wherein the 3D graphic model is constructed of any number of polygons. Each polygon is subdivided into triangles, while mapping the spatial orientation and scaling of each triangle to a predetermined spatial orientation and scale, using a combination of rotation, scaling, and linear translation. Each mapped triangle is shaded using 2D linear or bi-linear coloring map shading tools and then remapped to its original spatial orientation and scale using, a corresponding combination of rotation, scale, and linear translation, such as an inverse combination.

Preferably, mapping and remapping of each triangle is performed according to the linear transformation matrix

$$[ \begin{matrix}{rs}_{11} & {rs}_{12} & 0 \\ {rs}_{21} & {rs}_{22} & 0 \\ {t}_{x} & {t}_{y} & 1\end{matrix} ] ,$$

wherein rsᵢⱼ represent the rotation and scale, and tᵢ represents the translation. The linear transformation matrix can be derived by any appropriate method.

The linear transformation matrix may be derived by stretching a line from one vertex of the triangle to a point on the opposite edge of the triangle, such that the intensity of the color of the vertex and the point are identical. Then the triangle is rotated, so that the line is parallel to the y axis, thereby setting x to be constant. The triangle is translated so that the line is located at x=0 and then scaled, so that the Euclidean distance between the vertex placed at x<0 and the line equals the difference in the intensities of the vertex placed at x<0 and the line. Finally, the triangle is translated, so that the line is positioned at the x with the desired intensity value of the line.

The present invention is also directed to a method for texture mapping 3D graphic models using 2D graphic tools, wherein the 3D graphic model is constructed of any number of polygons. Each polygon is subdivided into triangles, while mapping the spatial orientation and scaling of each triangle to a predetermined spatial orientation and scale, using a combination of rotation, scaling, and linear translation. Texture mapping is performed on each mapped triangle using 2D linear or bi-linear coloring map shading tools and then remapped to its original spatial orientation and scale using, a corresponding combination of rotation, scale, and linear translation, such as an inverse combination.

The linear transformation matrix may be derived according to a 2D parametric domain by translating the triangle so that one of its vertices is at the origin, translating the 2D parametric domain so that the point in the domain which is to be mapped onto the vertex is at the origin and then finding (2×2) linear transform that maps the correct vectors in the domain to the two vectors of the triangle which join at the vertex of the triangle, placed at the origin.

All the above and other characteristics and advantages of the invention will be further understood through the following illustrative and non-limitative description of preferred embodiments thereof.

### BRIEF DESCRIPTION OF DRAWINGS

FIG. 1 schematically the general scheme of texture mapping a 3D model from a 2D parametric domain;

FIG. 2a schematically shows a triangle representing one of the polygons of the 3D graphic model; and

FIGS. 2b-2e schematically describe the steps of the method of shading a triangle, according to the present invention.

### DETAILED DESCRIPTION OF PREFERRED EMBODIMENTS

In light of the drawbacks of the prior art regarding 2D shading and texture mapping techniques (e.g., 2D linear or bi-linear coloring map shading tools), there is a need for an improved method by which 2D applications can be used for shading and texture mapping graphic models in a manner which will allow those models to appear to be 3D.

The present invention relates to the implementation of the smooth Gouraud shading technique in computer environments which do not support 3D graphics. This is achieved by using linear gradients, where in the context of the present invention linear gradients are color maps that linearly interpolate between two different colors.

In many applications, such as MFT, the color map is defined canonically in [−1,1]x[−1,1]. That is, when relating to the two colors C₁ and C₂, color C₁ is mapped to x=−1 and color C₂ is mapped to x=1. In 2D applications such as MFT, a canonical linear gradient could be mapped to any location, orientation, and scaled within the graphical model via the following linear transformation:

$$[ \begin{matrix}{rs}_{11} & {rs}_{12} & 0 \\ {rs}_{21} & {rs}_{22} & 0 \\ {t}_{x} & {t}_{y} & 1\end{matrix} ] , \qquad ( 1 )$$

wherein rsᵢⱼ define the rotation and scale, and tᵢ define the translation. Since the model is a 2D model, it is rotated, scaled and translated only in the x-y plane. The present invention shows how such simple linear transformations can be used to implement Gouraud shading technique to any 3D (projected) graphic model using 2D tools, such as 2D linear or bi-linear coloring map shading tools.

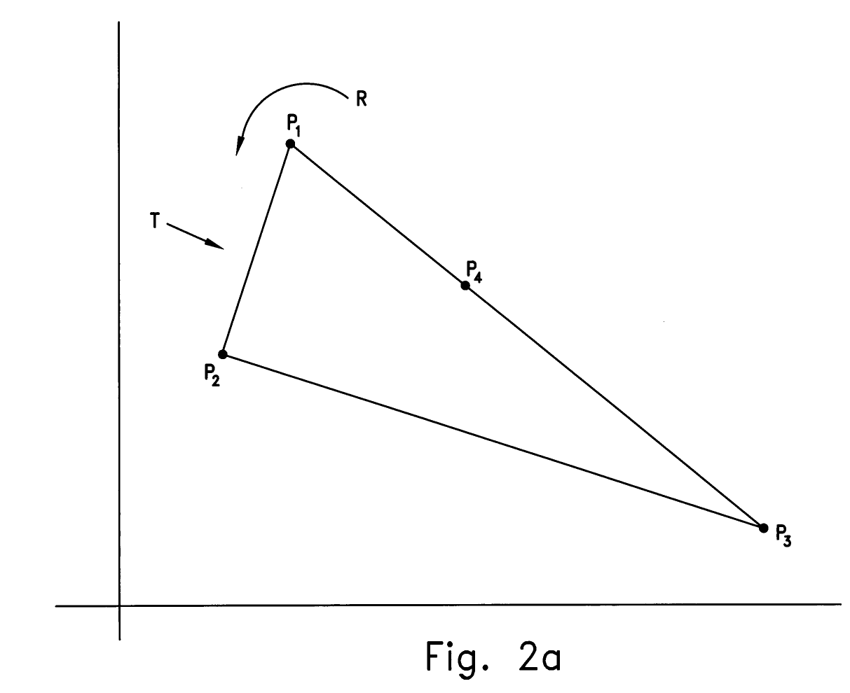

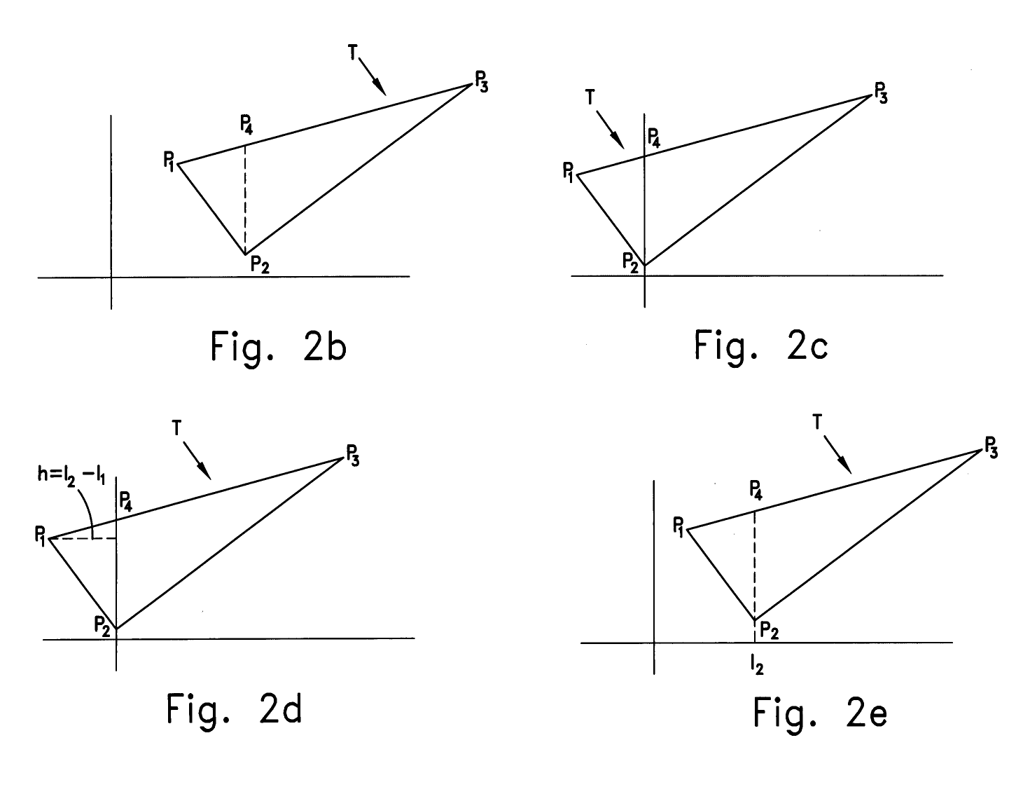

FIG. 2a shows a triangle T, wherein P₁, P₂, and P₃ are its three vertices. When shading triangle T, the intensity of the color of each point Pᵢ in the triangle, including the points on its edges, is Iᵢ. Assuming, without loss of generality, that the intensity at P₁ is less than, or equal to, the intensity at P₂, which in turn is less than, or equal to, the intensity at P₃, meaning that I₁≦I₂ and I₂≦I₃. Since vertices P₁ and P₃ are at the two ends of one edge of triangle T, and the color intensity changes gradually and continuously between them, there must be a point P₄ on edge P₁P₃ with intensity I₂.

Point P₄ can be defined by P₄=tP₃+(1−t)P₁, wherein t=(I₂−I₁)/(I₃−I₁). Being on the line through edge P₁P₃, point P₄ could be expressed as the above linear combination of P₁ and P₃, for some t. Since the intensity along edge P₁P₃ changes linearly from I₁ to I₃, the t selects the location along edge P₁P₃ where the intensity assumes the value of I₂.

Once the transformation matrix and P₄ are defined as described hereinabove, the following transformation steps are performed, such that triangle T is gradually painted by the canonical linear gradient, so that every point P₁ is painted in intensity Iᵢ:
1. rotate triangle T (along arc R, shown in FIG. 2a) so that line P₂P₄ is parallel to the y axis, thereby setting x to be constant;
2. translate triangle T so that line P₂P₄ is at x=0;
3. scale triangle (possibly in x only) so that the Euclidean distance from point P₁ to line P₂P₄ (shown in FIG. 2d as h) equals the color/intensity distance I₂−I₁. In other words, transformation matrix (1), shown hereinabove, relates the x coordinates in the drawing space to intensities in the color gradient space, thus the x-axis has a dual relation, relating both to distance and to intensities;
4. translate triangle T so that line P₂P₄ is positioned at x=I₂.

These four steps are schematically shown in FIGS. 2b-2e.

Once the above steps are mapped into a product of several matrices yielding linear transform matrix (1), triangle P₁P₂P₄ will be properly shaded. That is, P₁ is shaded in intensity I₁, P₂ is shaded in intensity I₂, and P₄ is shaded in intensity I₄. The shading is performed using a linear color gradient and all of the vertices of triangle P₁P₂P₄ are shaded correctly, so that any point Pᵢ in triangle P₁P₂P₄ is shaded with an intensity of Iᵢ.

However, according to steps 1-4 listed above, not only triangle P₁P₂P₄ will be shaded correctly, but also point P₃, and with it triangle P₂P₄P₃. To realize this result it is noted (as shown in FIG. 2a) that edge P₁P₄ (and hence edge P₁P₃) is a line in the canonical linear color gradient. Therefore, the color along this line changes linearly, wherein the intensity at P₁ is I₁ and at P₄ the intensity rises to I₄. As would be understood by those familiar with the art, in cases where the intensity is prescribed at two places along a line, in this case, at points P₁ and P₄, it is fully prescribed along the entire line, including P₃.

The fact that the intensity at P₃, I(P₃), is equal to I₃, can be proven by using the definition of P₄ (with intensity I₄=I₂) presented above:

$$\begin{matrix}I ( {P}_{3} ) = {I}_{1} + ( {I}_{2} - {I}_{1} ) \frac{‖ {P}_{3} - {P}_{1} ‖}{‖ {P}_{4} - {P}_{1} ‖} \\ = {I}_{1} + ( {I}_{2} - {I}_{1} ) \frac{‖ {P}_{3} - {P}_{1} ‖}{‖ t {P}_{3} + ( 1 - t ) {P}_{1} - {P}_{1} ‖} \\ = {I}_{1} + ( {I}_{2} - {I}_{1} ) \frac{‖ {P}_{3} - {P}_{1} ‖}{‖ t ( {P}_{3} - {P}_{1} ) ‖} \\ = {I}_{1} + \frac{{I}_{2} - {I}_{1}}{t} \\ = {I}_{1} + \frac{{I}_{2} - {I}_{1}}{\frac{{I}_{2} - {I}_{1}}{{I}_{3} - {I}_{1}}} \\ = {I}_{1} + {I}_{3} - {I}_{1} \\ = {I}_{3}\end{matrix}$$

When I₁=I₂, or I₂=I₃, or I₁=I₂=I₃, the mathematical treatment is a bit different. However, realizing that in those singular cases P₄ identifies with P₁ or P₃, or both, it is understood that the mathematical procedure in those cases is simpler. Finally, edges P₁P₂, P₁P₃, P₂P₃ all have colors that are linearly interpolated between the two end points, being merely lines inside the linear color gradient.

As shown above, linear color gradients can be efficiently used to shade any triangle with any three intensities at its three vertices, using only one linear transformation. This is true whether the three intensities are all different from one another, or whether there are any identities between them.

When attempting to shade the entire graphic model, one canonical linear color gradient is defined for the model, based on its color, and each polygon within the model is painted or shaded using a specific linear transform, as defined in Equation (1). If the viewer's eye moves around the objects of the model, while the light source remains fixed with respect to the object, the matrices, (i.e., the intensities), are computed only once. However, in cases where the intensity is dependent on the view direction, and thus is known only at run-time, it is necessary to reevaluate these matrices in every iteration.

Although the above refers to Gouraud shading, the present invention is not limited only to this technique. Although currently MFT and similar applications support only linear color gradient, bi-linear color gradients that blend between orthogonal colors in the plane could also be used according to the present invention. The development of bi-color linear gradients would allow various types of more complex shading techniques using the method of the present invention.

Another aspect of the present invention is that of texture mapping. According to the present invention, ordinary 2D tools, existing in applications such as MFT, are used to map texture onto 3D graphic models.

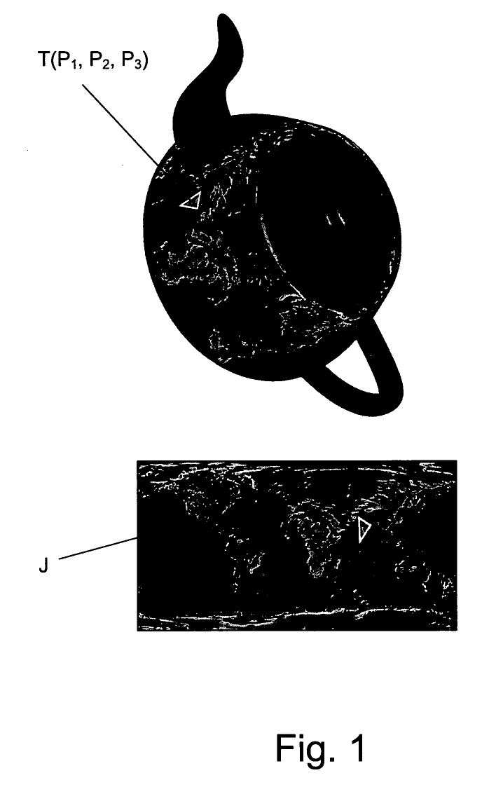

Referring to FIG. 1, every point P₁ in triangle T(P₁,P₂,P₃) must be matched to the (u,v) coordinates of domain J so that point P₁ matches the coordinate UVᵢ. In order to map texture correctly from 2D parametric domain J to model M, (UV₁,UV₂,UV₃) must be mapped to (P₁,P₂,P₃).

According to the method of the present invention the correct texture mapping is achieved by the following steps:
1. translate triangle T so that P₁ is at the origin (denoting this matrix transform M₁);
2. translate the UV domain so that UV₁ is at the origin; (denoting this matrix transform M₂;
3. find the (2×2) linear transform, denoted M₃, that maps 2D vectors

UV₁₂=UV₂−UV₁ and UV₁₃=UV₃−UV₁ to 2D vectors P₁₂=P₂−P₁ and P₁₃=P₃−P₁, respectively. As would be understood by those familiar with the art there are four degrees of freedom and four independent unknowns, in the general case of non-singular, degenerate, constraints, thus a unique solution exists. This solution could be found, for example, by posing this problem as the following linear system of constraints. Let

$${M}_{3} = [ \begin{matrix}{m}_{3}^{11} & {m}_{3}^{12} \\ {m}_{3}^{21} & {m}_{3}^{22}\end{matrix} ] .$$

Then, solve for the four m₃^{ij} coefficients of M₃ using the following four constraints:

$$\{ \begin{matrix}{P}_{12} = {M}_{3} \cdot {UV}_{12} , \\ {P}_{13} = {M}_{3} \cdot {UV}_{13} .\end{matrix}$$

The above steps of translation and linear (2×2) mapping are described as a product of matrices Mᵢ, i=1, 2, 3, yielding linear transform matrix (1), as M=M₂ M₃ M₁⁻¹. M₂ maps the UVᵢ coordinates into the origin, M₃ deforms the plane so the vectors points to the proper direction, and finally M₁⁻¹ brings the coordinates back from the origin to Pᵢ. Following the above steps ensures that triangle T, seen in FIG. 1, will be properly painted with the texture as prescribed by the texture triangle (UV₁,UV₂,UV₃), defined in 2D parametric domain J.

In light of the above, it would be understood to those familiar in the art that the present invention enables the handling and display of 3D geometry generated by software applications, such as Maya© and 3D Studio Max©, in pure 2D graphic systems, such as MFT.

Although the above refers to the shading and texture mapping of triangles it would be understood by those familiar with the art that the method of the present invention can be applied to any n-sided shaped polygon, which can be subdivided by any suitable graphics algorithm into n−2 (or more) triangles.

Although embodiments of the present invention have been described by way of illustration, it will be understood that the invention may be carried out with many variations, modifications, and adaptations, without departing from its spirit or exceeding the scope of the claims.

1. A method for shading 3D graphic models using 2D graphic tools, wherein the 3D graphic model is constructed of any number of polygons, comprising:
a. subdividing each polygon into triangles;
b. mapping the spatial orientation and scaling each triangle to a predetermined spatial orientation and scale using a combination of rotation, scaling, and linear translation;
c. shading each mapped triangle using 2D linear or bi-linear coloring map shading tools; and
d. remapping each shaded triangle to its original spatial orientation and scale using a corresponding combination of rotation, scale, and linear translation.

2. The method according to claim 1 wherein the mapping and remapping of each triangle is performed according to the linear transformation matrix
$$[ \begin{matrix}{rs}_{11} & {rs}_{12} & 0 \\ {rs}_{21} & {rs}_{22} & 0 \\ {t}_{x} & {t}_{y} & 1\end{matrix} ] ,$$
wherein rsᵢⱼ represent the rotation and scale, and tᵢ represents the translation, and wherein said linear transformation matrix can be derived by any appropriate method.

3. The method of claim 2, wherein the linear transformation matrix is derived according to the following steps:
a. stretching a line from one vertex of the triangle to a point on the opposite edge of said triangle, wherein the intensity of the color of said vertex and said point are identical;
b. rotating said triangle so that said line is parallel to the y axis, thereby setting x to be constant;
c. translating said triangle so that said line is located at x=0;
d. scaling said triangle so that the Euclidean distance between the vertex placed at x<0 and said line equals the difference in the intensities of the vertex placed at x<0 and said line; and
e. translating said triangle so that said line is positioned at the x with the desired intensity value of said line.

4. A method for texture mapping 3D graphic models using 2D graphic tools, wherein the 3D graphic model is constructed of any number of polygons, comprising;
a. subdividing each polygon into triangles;
b. mapping the spatial orientation and scale of each triangle to a predetermined spatial orientation and scale using a combination of rotation, scale, and linear translation;
c. performing texture mapping on each mapped triangle, using 2D linear or bi-linear coloring map shading tools; and
d. remapping each shaded triangle to its original spatial orientation and scale using a corresponding combination of rotation, scale, and linear translation.

5. The method according to claim 4 wherein the mapping of each triangle is performed according to the linear transformation matrix
$$[ \begin{matrix}{rs}_{11} & {rs}_{12} & 0 \\ {rs}_{21} & {rs}_{22} & 0 \\ {t}_{x} & {t}_{y} & 1\end{matrix} ] ,$$
wherein rsᵢⱼ represent the rotation and scale, and tᵢ represents the translation, and wherein said linear transformation matrix can be derived by any appropriate method.

6. The method of claim 5, wherein the linear transformation matrix is derived according to a 2D parametric domain, by performing the following steps:
a. translating the triangle so that one of its vertices is at the origin;
b. translating said 2D parametric domain so that the point in said domain which is to be mapped onto said vertex is at the origin; and
c. finding the (2×2) linear transform that maps the correct vectors in said domain to the two vectors of said triangle which join at said vertex of said triangle, placed at the origin.
